(19) United States
(12) Patent Application Publication
(10) Pub. No.: US 2014/0028554 A1
(43) Pub. Date: Jan. 30, 2014

(54) RECOGNIZING GESTURE ON TACTILE INPUT DEVICE

(71) Applicants: Andrew De Los Reyes, Belmont, CA (US); Ryan Tabone, San Francisco, CA (US)

(72) Inventors: Andrew De Los Reyes, Belmont, CA (US); Ryan Tabone, San Francisco, CA (US)

(73) Assignee: GOOGLE INC., Mountain View, CA (US)

(21) Appl. No.: 13/559,216

(22) Filed: Jul. 26, 2012

(51) Int. Cl. G06F 3/033; G06F 3/02; G06F 3/041

(52) U.S. Cl. 345/158; 345/173; 345/168

(57) ABSTRACT

A non-transitory computer-readable storage medium may comprise instructions stored thereon for recognizing gestures on a tactile input device. The instructions may be configured to cause a computing system to at least receive, from a sensor of the tactile input device, a signal representing a first contact on the tactile input device and subsequent release of the first contact from the tactile input device, receive, from the sensor of the tactile input device, a signal representing a second contact on the tactile input device after the first contact is released, the second contact being maintained and changing location on the tactile input device, and recognize the first contact and the second contact as a single gesture if the second contact occurs within a re-tap threshold period of time after the first contact, and the second contact begins within a maximal threshold distance on the tactile input device from the first contact.

### TECHNICAL FIELD

This description relates to an input for use with a computing device, such as a tactile input device or trackpad.

### BACKGROUND

Computing devices, such as laptop or notebook computers, may include tactile input devices, such as trackpads. The tactile input device may replace the mouse by providing directions of movement to other components of the computing device. The directions of movement may be based on movement of the user's finger(s) across the tactile input device. In some embodiments, the tactile input device may not include buttons corresponding to the left and right buttons on a mouse.

### SUMMARY

According to one general aspect, a non-transitory computer-readable storage medium may comprise instructions stored thereon for recognizing gestures on a tactile input device. When executed by at least one processor, the instructions may be configured to cause a computing system to at least receive, from a sensor of the tactile input device, a signal representing a first contact on the tactile input device and subsequent release of the first contact from the tactile input device, receive, from the sensor of the tactile input device, a signal representing a second contact on the tactile input device after the first contact is released, the second contact being maintained and changing location on the tactile input device, and recognize the first contact and the second contact as a single gesture if the second contact occurs within a re-tap threshold period of time after the first contact, and the second contact begins within a maximal threshold distance on the tactile input device from the first contact.

According to another general aspect, a non-transitory computer-readable storage medium may comprise instructions stored thereon for recognizing gestures on a tactile input device. When executed by at least one processor, the instructions may be configured to cause a computing system to at least receive, from a sensor of the tactile input device, a signal representing a first contact on the tactile input device, receive, from the sensor of the tactile input device, a signal representing a second contact on the tactile input device, and recognize the first contact and the second contact as simultaneous if the second contact begins within a concurrent tap threshold time of when the first contact begins, the second contact begins within a maximal threshold distance of the first contact, and the first and second contacts are released within a concurrent release threshold time of each other.

According to another general aspect, a non-transitory computer-readable storage medium may comprise instructions stored thereon for ignoring spurious clicks on a tactile input device. When executed by at least one processor, the instructions may be configured to cause a computing system to at least receive, from a sensor of the tactile input device, a signal representing a first contact on the tactile input device, the first contact being maintained and moving across the tactile input device, receive, from the sensor of the tactile input device, a signal representing a second contact on the tactile input device, the second contact beginning at least a threshold period of time after a beginning of the first contact and while the first contact is moving across the tactile input device, and ignore the second contact based on the second contact beginning at least the threshold period of time after the beginning of the first contact and while the first contact is moving across the tactile input device.

According to another general aspect, a computing system may comprise a display, a tactile input device comprising at least one sensor, at least one processor, and at least one memory device. The at least one processor may be configured to execute instructions, receive input signals from the at least one sensor of the tactile input device, and send output signals to the display. The at least one memory device may comprise instructions stored thereon that, when executed by the at least one processor, are configured to cause the computing system to at least present, by the display, an object being dragged across the display based on a first drag contact and a second drag contact received on the sensor of the tactile input device, the second drag contact beginning within a re-tap threshold period of time after the first drag contact on the sensor is released, and the second drag contact beginning within a maximal threshold distance on the sensor from the first contact.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram of a computing device including a tactile input device according to an example embodiment.

FIG. 1B is a diagram of the tactile input device and related components according to an example embodiment.

FIG. 1C is a diagram of a sensor grid according to an example embodiment.

FIG. 2A is a diagram of the sensor grid showing distances between two overlapping contacts detected on the tactile input device according to an example embodiment.

FIG. 2B is a diagram showing a single finger contacting the tactile input device according to an example embodiment.

FIG. 2C is a graph showing contacts and thresholds on the tactile input device according to an example embodiment.

FIG. 2D is a flow diagram of an exemplary process that may be used to recognize a single gesture

FIG. 3A is a diagram of the sensor grid showing a distance between two non-overlapping contacts detected on the tactile input device according to an example embodiment.

FIG. 3B is a diagram showing two fingers contacting the tactile input device according to an example embodiment.

FIG. 3C is a graph showing contacts and thresholds on the tactile input device according to another example embodiment.

FIG. 3D is a flow diagram of an exemplary process that may be used to recognize a single gesture.

FIG. 4A is a diagram of a sensor grid showing a moving contact and an inadvertent contact detected on the tactile input device according to an example embodiment.

FIG. 4B is a diagram of the sensor grid showing a central area and an outer area according to an example embodiment.

FIG. 4C is a flow diagram of an exemplary process that may be used to ignore an inadvertent contact with the tactile input device.

FIG. 5 shows an example of a computer device and a mobile computer device that may be used to implement the techniques described here.

Like reference numbers in the drawings indicate like elements.

### DETAILED DESCRIPTION

A tactile input device for use with a computing device can be used to communicate with and control operations of the computing device. The tactile input device may include, for example, a trackpad or touch pad. The tactile input device can be configured to be contacted by a user on a top surface of the tactile input device to trigger an electronic signal within the computing device. For example, a user can slide or move one or more fingers, or in some cases, knuckles or a portion of a hand, across the top surface of the tactile input device to move a cursor visible on a display of the computing device. The tactile input device can also include a “click” function to allow the user to for example, click or select items on the display, or to actuate a right click function. Various tactile input devices described herein can allow a user to actuate a click function by exerting or applying a force on a top surface of the tactile input device at any location on the top surface. The tactile input device may also allow the user to actuate the click function on only some locations of the top surface, such as within a central area of the top surface. In some implementations, the tactile input device may not have a specific sensor location that the user finds to actuate a click function.

As used herein, a reference to a top view in a figure refers to a view as viewed by a user during use of the tactile input device. For example, a top view can refer to a view of the tactile input device as disposed within a computing device such that the user can contact the top surface of the tactile input device to initiate an action within the computing device.

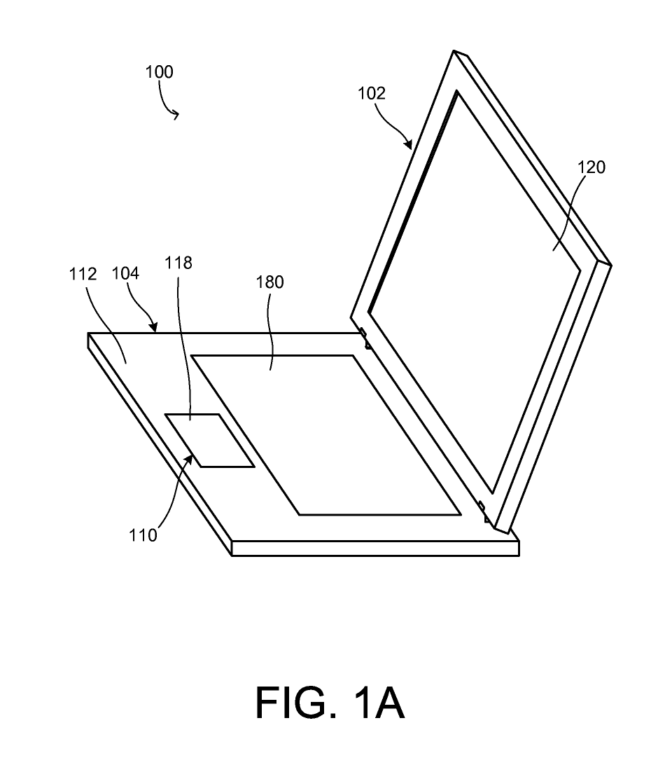

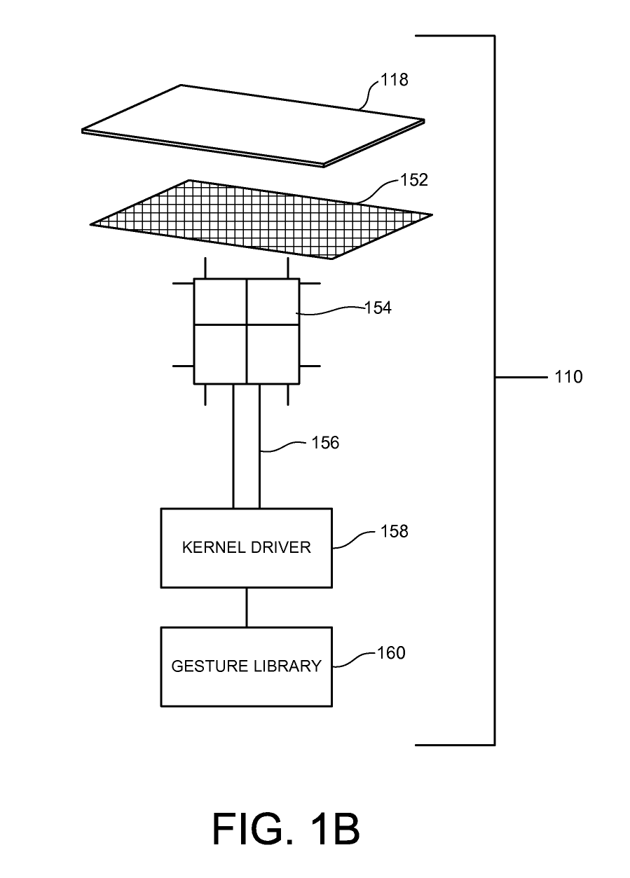

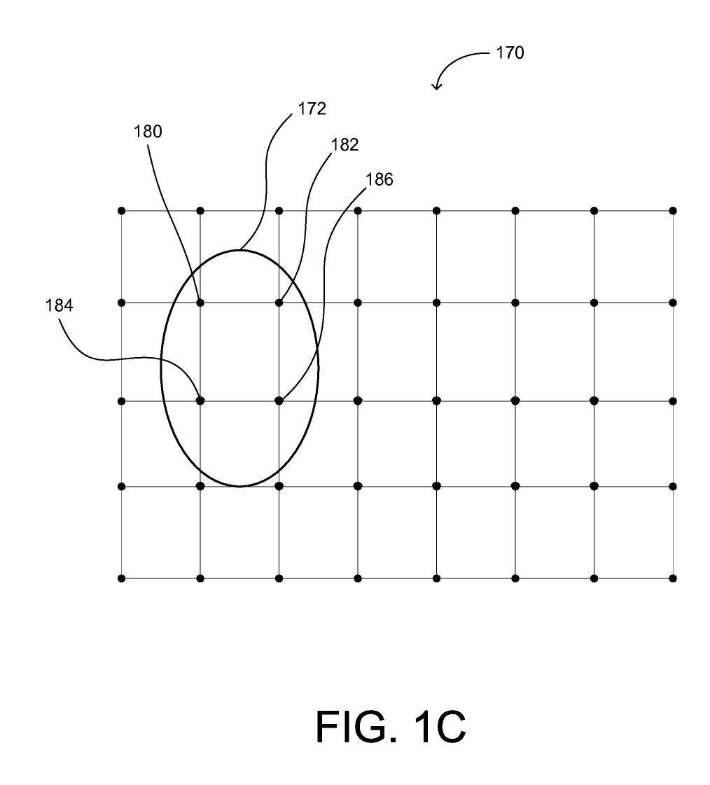

FIG. 1A is a diagram of a computing device 100 including a tactile input device 110 according to an example embodiment. Computing device 100 includes a display portion 102 and a base portion 104. Display portion 102 may include a display 120 that can be, for example, a liquid crystal display (LCD), a light emitting diode (LED) display, or other type of electronic visual display device. The base portion 104 can include, among other components, a tactile input device 110, a housing 112, and a keyboard portion 180.

The tactile input device 110 can include a sensor (not shown) and a top surface 118, configured to receive inputs (e.g., a touch, swipe, scroll, drag, click, hold, tap, combination of inputs, etc.) from a user. The sensor can be activated when a user enters an input on the top surface 118 of the tactile input device 110, and can communicate electronic signals within the computing device 100. The sensor can be, for example, a flame-retardant class-4 (FR3) printed circuit board. Other components, such as a dome switch, adhesive sheets, and cables (not shown), may also be integrated in computing device 100 to process input by a user via tactile input device 110 or keyboard 180. Various elements shown in the display 120 of the computing device 100 may be updated based on various movements of contacts on the tactile input device 110 or the keyboard 180.

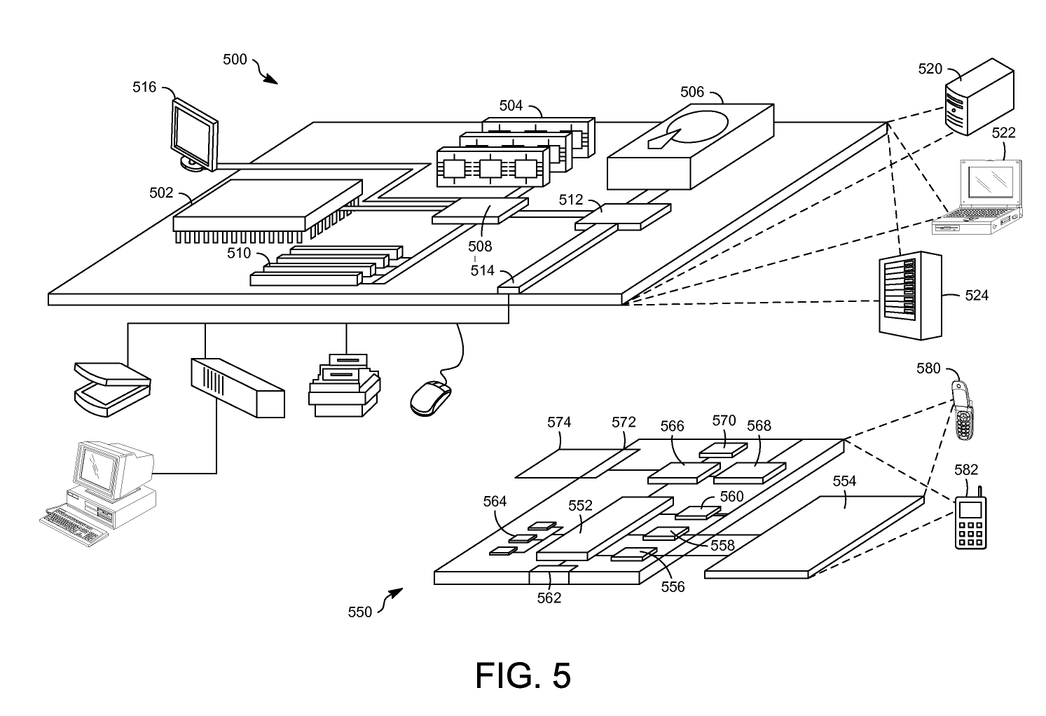

Tactile input devices, such as tactile input device 110, may be used in self-contained portable laptop computers such as device 100, and do not require a flat surface near the computer. The tactile input device 110 may be positioned close to the keyboard 180. The tactile input device 110 may only use very short finger movements to move a cursor across the display 120. While advantageous, this also makes it possible for a user's thumb to move the mouse cursor accidentally while typing, or for a user to unintentionally move the cursor, for example when a finger first touches the tactile input device 110. Tactile input device functionality is also available for desktop computers in keyboards with built-in touchpads, and in mobile devices, as described in more detail below with respect to FIG. 5.

The components of the input devices (e.g., 110, 180) described here can be formed with a variety of different materials such as plastic, metal, glass, ceramic, etc. used for such components. For example, the top surface 118 and base member 104 can each be formed, at least in part, with an insulating material and/or conductive material such as a stainless steel material, for example, SUS301 or SUS304.

Some tactile input devices and associated device driver software may interpret tapping the tactile input device surface 118 as a click, and a tap followed by a continuous pointing motion (a “click-and-a-half” or “tap-and-a-half”) can indicate dragging. Tactile input devices may allow for clicking and dragging by incorporating button functionality into the surface of the tactile input device itself (e.g., surface 118). To select, a user may press down on the surface 118 instead of a physical button. To drag, instead performing a “click-and-a-half” or “tap-and-a-half” technique, a user may click or tap-and-release, then press down while a cursor is positioned on the object in display area 120, drag without releasing pressure, and let go when done. Tactile input device drivers (not shown) can also allow the use of multiple fingers to facilitate other mouse buttons, such as two-finger tapping for a right-click.

Some tactile input devices have “hotspots,” which are locations on the tactile input device 110 used for functionality beyond a mouse. For example, on certain tactile input devices 110, moving the finger along an edge of the tactile input device 110 may act as a scroll wheel, controlling the scrollbar and scrolling the window in a display 120 that has the focus (e.g., scrolling vertically or horizontally). Certain tactile input devices 110 may use two-finger dragging for scrolling. Additionally, some tactile input device drivers support tap zones, regions where a tap will execute a function, for example, pausing a media player or launching an application. All of these functions may be implemented in tactile input device driver software, and these functions can be modified or disabled.

In some computing devices, such as computing device 100, the tactile input device 110 may sense any number of fingers (such as up to five, or more) simultaneously, providing more options for input, such as the ability to bring up a menu by tapping two fingers, dragging two fingers for scrolling, or gestures for zoom in or out or rotate. Additionally, although input device 110 is depicted as a rectangle, it will be appreciated that input device 110 could be formed in a different shape, such as a circle, without departing from the scope of the techniques described here. The functionalities described herein, such as “click-and-a-half” or “tap-and-a-half” to click and drag, or multiple simultaneous fingers to right-click, bring up a menu, scroll, or zoom, may be interpreted by a gesture library as a single gesture.

FIG. 1B is a diagram of the tactile input device 110 and related components according to an example embodiment. Tactile input device 110 includes the surface 118, a sensor 152, a controller 154, a bus 156, a kernel driver 158, and a gesture library 160.

The surface 118 may be configured to be contacted by a user to actuate and trigger an electrical response within the computing device 100. The surface 118 may, for example, be on top of the tactile input device 110 and above the sensor 152, parallel and flush or nearly flush with other components of the computing device 100 (shown in FIG. 1A), such as a top surface of the base portion 104. The surface 118 may be operably coupled to the sensor 152. The sensor 152 can be activated when a user enters an input (e.g., a touch, swipe, or a click), such as by applying pressure on the top surface 118 of the tactile input device 110. The sensor 152 can be, for example, a flame-retardant class-4 (FR4) printed circuit board. The sensor 152 may be responsive to applications of pressure on the surface 118 and/or sensor 152, and may provide signals to a controller 154 indicating changes in resistance and/or capacitance in the sensor 152 based on the applications of pressure.

Controller 154 may be operably coupled to sensor 152. Controller 154 may be an embedded microcontroller chip and may include, for example, read-only firmware. Controller 154 may include a single integrated circuit containing a processor core, memory, and programmable input/output peripherals. Bus 156 may be a PS/2, I2C, SPI, WSB, or other bus. Bus 156 may be operably coupled to controller 154 and may communicate with kernel driver 158. Kernel driver 158 may include firmware and may also include and/or communicate with gesture library 160. Gesture library 160 may include executable code, data types, functions, and other files (such as JAVASCRIPT files) which may be used to process input to tactile input device 110 (such as multitouch gestures). Gesture library 160, in combination with kernel driver 158, bus 156, controller 154, sensor 152, and surface 118, may be used to implement various processes, such as the processes described herein.

The components of the tactile input device 110, and their interrelationships, as shown and described with respect to FIG. 1B, are merely an example. Functionalities of the gesture library 160 may be performed by the kernel driver 158 and/or controller 154, an operating system or application. The functionalities may, for example, be stored and/or included on a non-transitory computer-readable storage medium comprising instructions stored thereon that, when executed by a processor or the controller 154 of the computing system 100, are configured to cause the computing system 100 to perform any combination of the functionalities or processes described herein. Or, the tactile input device 110 may be designed as an application specific integrated circuit (ASIC) to perform the functions described herein.

FIG. 1C is a diagram of a sensor grid 170 according to an example embodiment. The sensor grid 170 may be included as part of the tactile input device 110, such as part of sensor 152 shown in FIG. 1B. Other implementations are possible, and the specific depiction of sensor grid 170 shown in FIG. 1C is merely for illustration. For example, the grid 170 may have any number of columns and rows, such as nine columns and twelve rows (instead of the eight columns and five rows shown in FIG. 1C), and may be formed in another shape (e.g., circular). The sensor grid 170 may include any number sensors, such as sensors 180, 182, 184, 186. The sensors 180, 182, 184, 186 may be spaced any distance (such as a few millimeters) apart from each other and may be designed to sense tactile input. The sensors 180, 182, 184, 186 may sense tactile input by sensing applications of pressure to the surface 118 of the tactile input device 110 (shown in FIGS. 1A and 1B), such as by detecting or determining resistance and/or capacitance levels. The resistance and/or capacitance levels may be changed by the received tactile input, such as changes or applications of pressure to the surface 118 and/or sensor 152.

Input 172, which may be a fingerpad contact, represents a position on the grid 170 when a user places a finger on the tactile input device 110. As shown in FIG. 1C, input 172 may span several rows and columns of sensors 180, 182, 184, 186 on grid 170. The sensors 180, 182, 184, 186, controller 156, kernel driver 158, and/or gesture library 160 may sense and/or determine an amount of pressure applied by the user's finger based on changes in the resistance and/or capacitance, and/or based on the number or area of sensors 180, 182, 184, 186 that detect the user's finger contacting the surface 118.

As discussed above, the tactile input device 110 may recognize a “tap-and-a-half” or “click-and-a-half” as a single gesture. The “tap-and-a-half” or “click-and-a-half” may include a first tap or application of pressure on the tactile input device 110, followed by a release of the first tap or application of pressure, followed by a second tap or application of pressure on the tactile input device 110, with the second tap or application of pressure being maintained and moving or changing location on the tactile input device 110. The single gesture recognized by the gesture library 160 may be a mouse button down then move, rather than a mouse button down, mouse button up, then move. The single gesture (mouse button down then move) recognized by the gesture library may also be considered a press-and-move mouse gesture, click-and-move mouse gesture, or a mouse pressed event (mousePressed) and mouse dragged event (mouseDragged). If the second tap or application of pressure is released, the gesture library 160, or other component of the tactile input device 110 or computing device 100, may recognize the release as a mouse release event (mouseReleased).

For “tap-and-a-half” or “click-and-a-half”, the two taps, contacts, or applications of pressure on the tactile input device 110 should be close together, such as within a maximal threshold distance from each other, to ensure that the user was attempting to tap the same spot on the tactile input device 110. The first and second taps, contacts, or applications of pressure on the tactile input device 110 should also be within a re-tap threshold period of time of each other, to ensure that the user is attempting the double-tap, and has not simply made a second, unrelated tap, contact, or application of pressure on the tactile input device 110. The gesture library 160 may also require the first tap, contact, or application of pressure on the tactile input device 110 to be released within a release threshold period of time from an initiation of the first tap, contact, or application of pressure on the tactile input device 110, to ensure that the second tap, contact, or application of pressure on the tactile input device 110 is a re-tap, and not a new, unrelated tap, contact, or application of pressure. The gesture library 160 may also require the second tap, contact, or application of pressure on the tactile input device 110 to occur at least a pause threshold period of time after the release of the first tap, contact, or application of pressure on the tactile input device 110, to ensure that the second tap, contact, or application of pressure on the tactile input device 110 is a distinct re-tap, and not an accidental release and re-application of pressure. The gesture library 160 may also require the second tap, contact, or application of pressure on the tactile input device 110 to remain stationary on the tactile input device 110 at least a stationary threshold period of time after the initiation of the second tap, contact, or application of pressure on the tactile input device 110, to ensure that the second tap, contact, or application of pressure was intended as a tap or click and/or as part of a tap-and-a-half or click-and-a-half gesture.

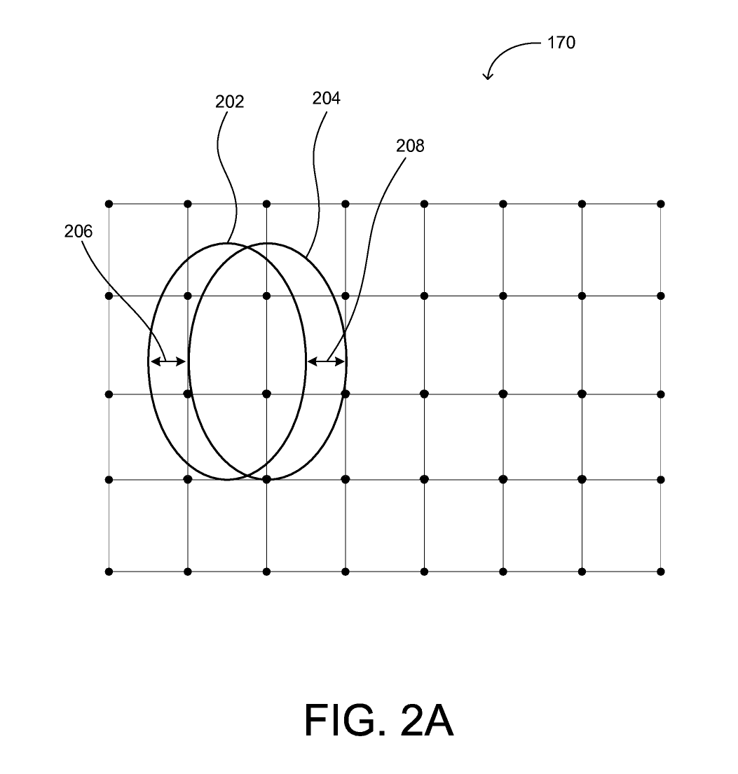

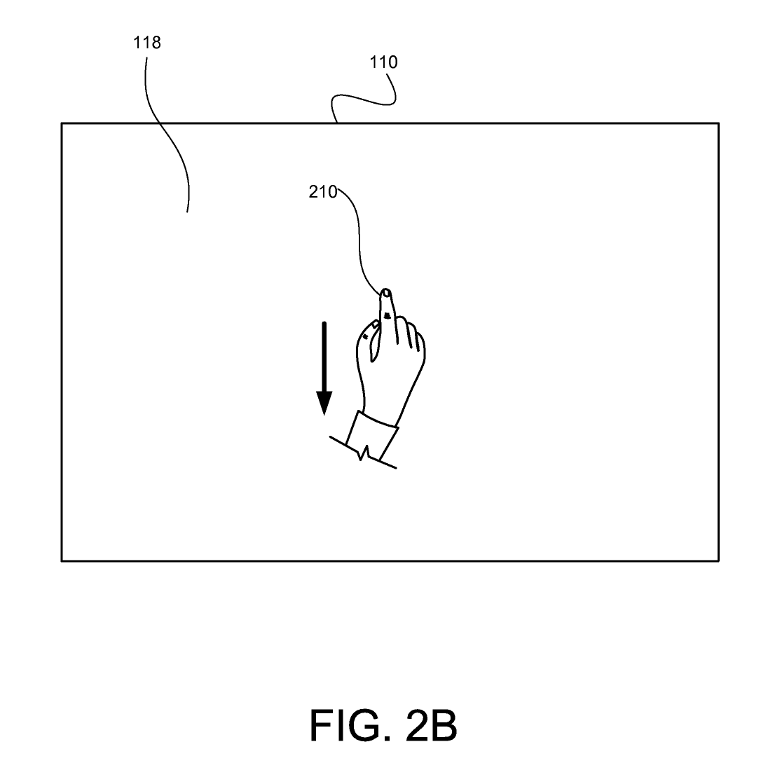

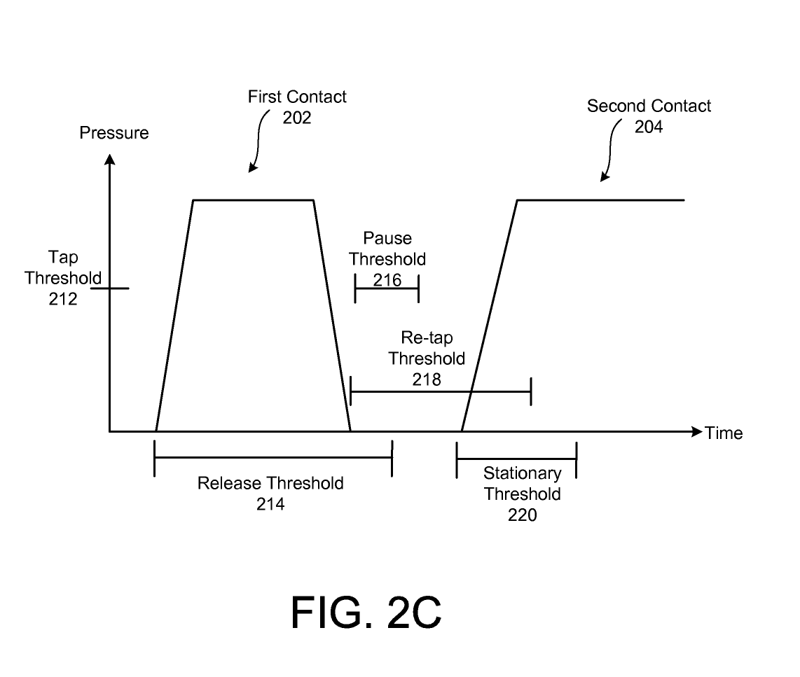

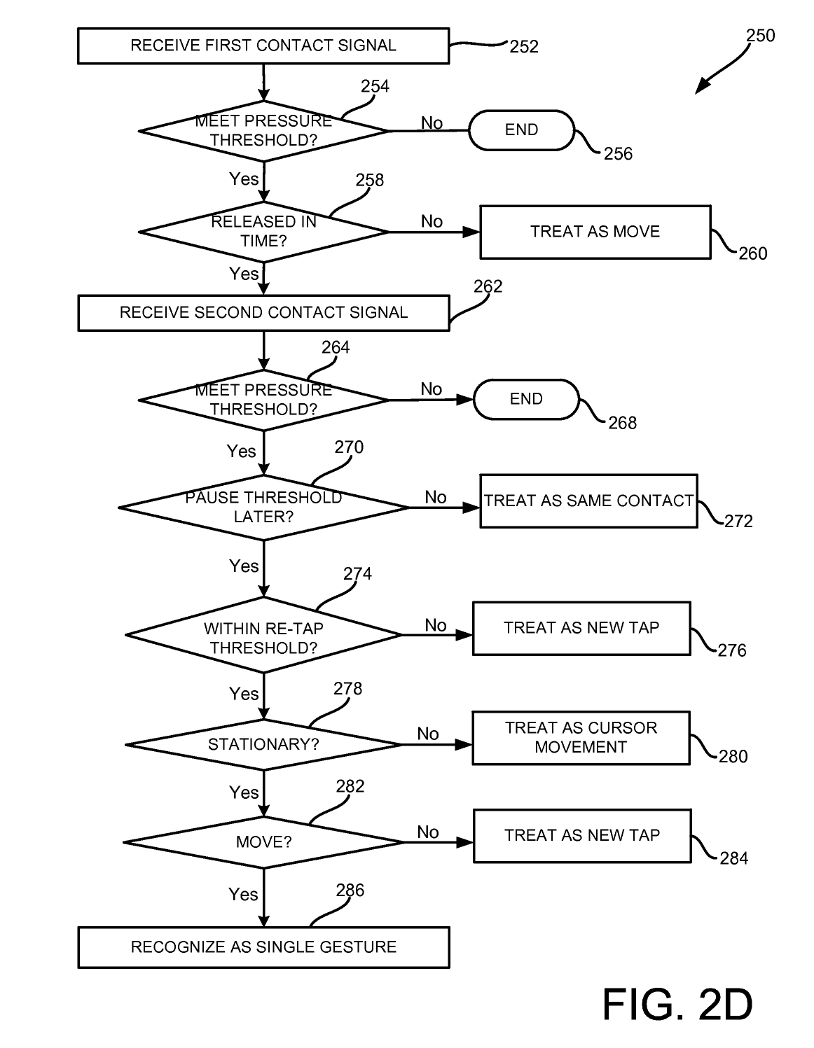

FIG. 2A is a diagram of the sensor grid 170 showing distances between two overlapping taps, contacts 202, 204, or applications of pressure detected on the tactile input 110 device according to an example embodiment. The overlapping contacts 202, 204, which may be examples of the input 172 shown in FIG. 1C, may not be concurrent in time. The first contact 202 may have occurred first, been released, and be followed by the second contact 204. A distance 206 may be measured from an outer portion on a first side, such as a left side, of each contact 202, 204, and/or a second distance 208 may be measured from an outer portion of a second side, such as a right side, of each contact 202, 204. Or, the distance may be measured from a central portion of each contact 202, 204. The tactile input device 110 may average multiple distances, or take a longest or shortest distance, between the contacts 202, 204, to determine whether the two contacts 202, 204 were within the threshold distance of each other.

The contacts 202, 204 may result from a user tapping his or her finger on the surface 118 of the tactile input device 110. FIG. 2B is a diagram showing a single finger 210 contacting the surface 118 of the tactile input device 110 according to an example embodiment. A contact, such as the finger 210, may exert pressure on the surface 118, release the pressure, re-exert pressure, and drag downward on the tactile input device 110.

FIG. 2C is a graph showing contacts 202, 204 and thresholds on the tactile input device 110 (not shown in FIG. 2C) as a function of time, according to an example embodiment. Both contacts 202, 204 may be required to meet pressure thresholds. In example embodiments, both contacts 202, 204 may be required to meet a same Tap Threshold 212, or may be required to meet different thresholds, with either the first or second contact 202, 204 being held to a higher threshold requirement than the other contact 202, 204, or the amount of pressure applied by the contacts 202, 204 may be required to be within a threshold difference.

The first contact 202 may be required to be released within a Release Threshold 214 period of time from the initiation of the first contact 202. If the first contact 202 is not released within the Release Threshold 214 period of time, then the first contact 202 may not be considered a tap, according to an example embodiment. The Release Threshold 214 may be two hundred milliseconds, according to an example embodiment.

The second contact 204 may be required to begin at least a Pause Threshold 216 period of time after the first contact 204 ends. The Pause Threshold 216 may ensure that the first contact 204 was intentionally released, and that there was not simply an accidental reduction in pressure. The Pause Threshold 216 may be one hundred and fifty milliseconds, according to an example embodiment.

The second contact 204 may also be required to begin no more than a Re-tap Threshold 218 period of time after the first contact 202 ends. The Re-tap Threshold 218 may ensure that the second contact 204 is indeed a “re-tap”, and not simply a later tap, contact, or application of pressure on the tactile input device 110.

The second contact 204 may also be required to remain stationary for at least a Stationary Threshold 220 period of time after beginning before moving or changing location on the tactile input device 110. The Stationary Threshold 220 may ensure that the second contact 204 is indeed a “re-tap”, and not simply a sliding of the user's finger 210 across the tactile input device 110.

FIG. 2D is a flow diagram of an exemplary process 250 that may be used to recognize a single gesture. The order of operations shown in FIG. 2D is merely an example, and the operations may occur in other orders than that shown in FIG. 2D. The computing system 100, including the controller 154, kernel driver 158, and/or gesture library 160, may receive a signal from the sensor 152 of the tactile input device 110 (252). The signal may represent the first contact 202 of the user's finger 210 on the surface 118 of the tactile input device 110. The signal may also indicate the release of the first contact 202. While the “signal” has been referred to as a single signal indicating the initiation and release of the first contact 202, the “signal” may include multiple signals indicating the initiation, maintaining, and release of the first contact 202.

The computing system 100 may determine whether the first contact 202 met the tap threshold 212 (254), ensuring that a minimum amount of pressure was applied to the surface 118 of the tactile input device 210 for the contact 202 to be recognized as an input into the computing device 100. If the first contact 202 did not meet the tap threshold 212 of pressure, then the process 250 may end (256).

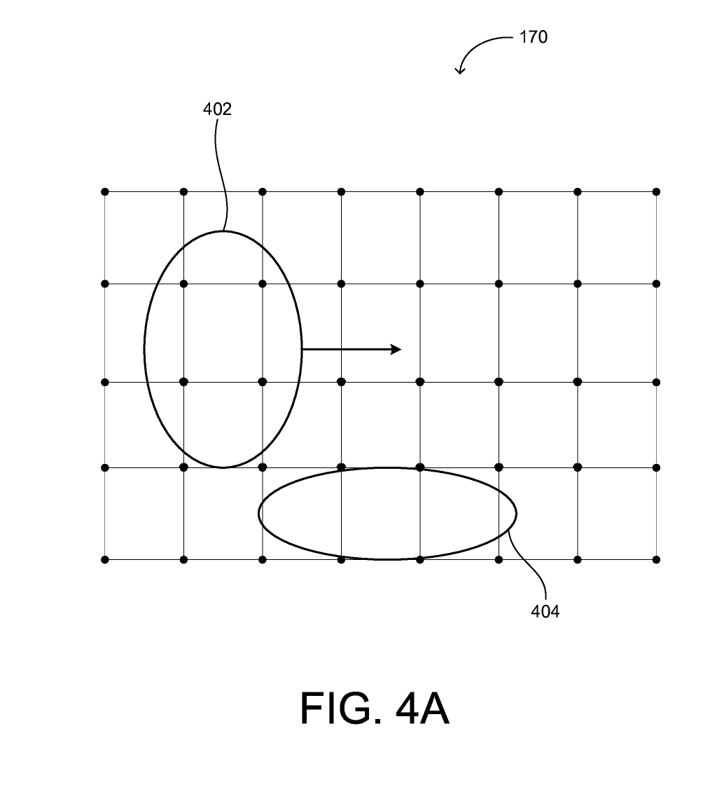

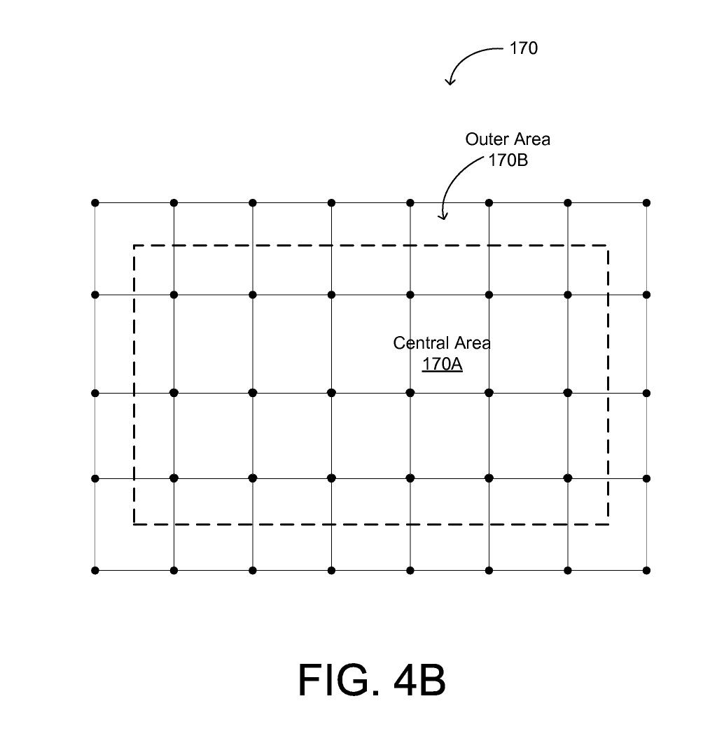

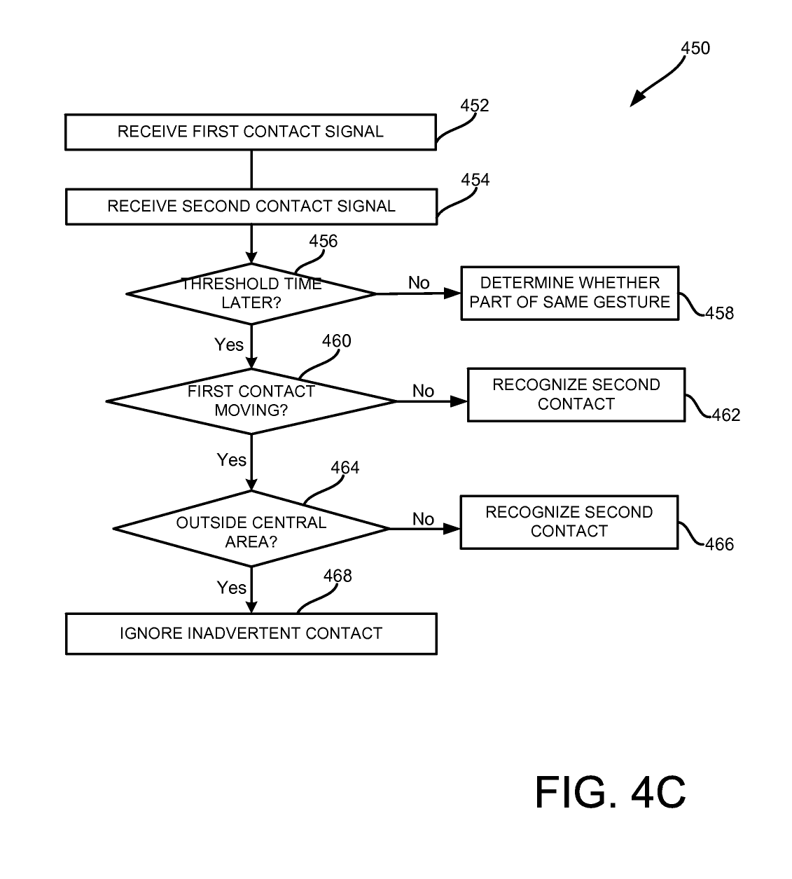

The computing system 100 may also determine whether the first contact 202 was within a central area of the tactile input device 110. The central area is discussed further with respect to FIG. 4B. If the first contact 202 was not within the central area, then the computing device 100 may ignore the first contact 202 for the purpose of recognizing the single gesture (286).

If the first contact 202 did meet the tap threshold 212, and the first contact 202 was within the central area, then the computing system 100 may determine whether the user released the first contact 202 within the release threshold 214 period of time (258), such as whether the user released or relieved the pressure on the sensor 118 of the tactile input device 110 within the release threshold 214 period of time. In an example embodiment, the computing system 100 may determine whether the user released the first contact 202 within the release threshold 214 period of time without a mouse movement or movement across the tactile input device 110. If the first contact 202 is not released within the release threshold 214 period of time, then the computing system 100 may treat the first contact 202 as simply a mouse movement (260). If the first contact 202 is released within the release threshold 214 period of time (either without the mouse or tactile input device movement or regardless of whether there was mouse or tactile input movement), then other events, determinations, and/or processes may result in the computing system 100 recognizing a single gesture.

After the first contact 202 is released, the computing system 100, including the controller 154, kernel driver 158, and/or gesture library 160, may receive another signal from the sensor 152 of the tactile input device 110 (262). The signal may represent the second contact 204 of the user's finger 210 on the surface 118 of the tactile input device 110. The signal may also indicate the release of the second contact 204. While the “signal” has been referred to as a single signal indicating the initiation and release of the second contact 204, the “signal” may include multiple signals indicating the initiation, maintaining, moving, and/or release of the second contact 202.

The computing system 100 may determine whether the second contact 204 met the tap threshold 212, or whether the user applied sufficient pressure to the surface 118 of the tactile input device 110 (264). In an example embodiment, the computing system 100 may evaluate each tap or contact 202, 204 independently, applying the same tap threshold 212 to each tap or contact 202, 204. In another example embodiment, the computing system 100 may also determine whether the second contact 204 met a different pressure threshold than was applied to the first contact 202. The pressure threshold applied to the second contact 204 may be higher or lower than the pressure threshold applied to the first contact 202. The computing system 100 may also determine whether the pressure applied by the two contacts 202, 204 were within a threshold difference of each other, according to an example embodiment. If the second contact 204 did not meet the pressure threshold (such as the tap threshold 212), then the process 250 may end (268), and the computing system 100 may ignore the second contact 204.

The computing system 100 may also determine whether the second contact 204 was within the central area of the tactile input device 110, discussed further with respect to FIG. 4B. If the second contact 204 was not within the central area, then the computing device 100 may ignore the second contact 204 for the purpose of recognizing the single gesture (286).

If the second contact 204 did meet the pressure threshold and was within the central area, then the computing system 100 may determine whether the second contact 204 began at least the pause threshold 216 period of time after the first contact 202 ended (270). The pause threshold 216 may ensure that the user intentionally lifted his or her finger 210 to make the “tap-and-a-half” or “click-and-a-half”, and the second contact 204 did not result from the user inadvertently lifting and replacing his or her finger 210 onto the surface 118 of the tactile input device 110. If the second contact 204 began sooner than the pause threshold 216 after the first contact 202 ended, then the computing system 100 may treat the second contact 204 as part of the same contact, tap, or application of pressure as the first contact 202 (272).

If the second contact 204 did begin at least the pause threshold 216 after the first contact 202, then the computing system 100 may determine whether the second contact 204 began within a re-tap threshold 218 period of time after the first contact 202 (274). If the second contact 204 did not begin within the re-tap threshold 218 after the first contact 202, then the second contact 204 may be unrelated to the first contact 204, and the computing system 100 may treat the second contact 204 as a new tap (276).

If the second contact 204 began within the re-tap threshold 218 after the first contact 202 was released, then the computing system 100 may determine whether the second contact 204 remained stationary, or did not move or change location on the surface 118 of the tactile input device 110, for a least the stationary threshold 220 period of time (278). If the second contact 204 did not remain stationary for at least the stationary threshold period of time, then the computing system 100 may treat the second contact 204 as cursor movement rather than as a new tap or click (280). In an example embodiment, if the second contact 204 did remain stationary for at least the stationary threshold 220, then the computing system 100 may recognize the first and second contacts 202, 204 as a single gesture (286), as discussed below.

In another example embodiment, if the second contact 204 did remain stationary for at least the stationary threshold 220, then the computing system 100 may determine whether the second contact 204 moved across the surface 118 of the tactile input device 110 after the stationary period (282). If the second contact 204 did not move, then the computing system 100 may treat the second contact 204 as a new or second click or tap from the first click 204 (284).

If the second contact 204 did move after the stationary period, then the computing system 100 may recognize the first and second contacts 202, 204 as a single gesture (286). The computing system 100 may recognize the first and second contacts 202, 204 as, for example, a drag, a press-and-move mouse gesture, or a mouse pressed event and a mouse dragged event. If the second contact 204 is released, then the computing system 100 may also recognize a mouse release event after the press-and-move or mouse pressed event and mouse dragged event, according to an example embodiment. The computing system 100 may, for example, send a mouse pressed signal and a mouse dragged signal to an application executing on the computing system 100. In response, the computing system 100 may display an object on the display 120 being dragged across the display 120.

In an example embodiment, the computing system 100 may disable the recognition of the single gesture (286) after the computing system has received input via the keyboard 180. The computing system 100 may disable the recognition of the single gesture after receiving a non-modifier key input on the keyboard 180, where a non-modifier key input may include receiving any key input other than control (Ctrl-), shift (Shift-), and/or alter (Alt-), because these keys may modify the gesture or tactile input device 110 input. The computing device 100 may disable the recognition of the single gesture for a keystroke threshold period of time after the keyboard 180 input, such as one hundred milliseconds or five hundred milliseconds, or a power of two, such as one hundred twenty-eight milliseconds, two hundred fifty-six milliseconds, or five hundred twelve milliseconds, as non-limiting examples.

A user may also use the tactile input device 110 to make a right-click input. The user may use the tactile input device 110 to make the right-click gesture by, for example, tapping on the tactile input device 110 with two fingers at the same time, or simultaneously. However, the user may have difficulty tapping on the tactile input device 110 with both fingers at exactly the same time. Because the user's fingers have different lengths, the user may also have difficulty applying similar amounts of pressure to the tactile input device 110 with both fingers. According to an example embodiment, the computing device 100 may treat the two taps, clicks, contacts, or applications of pressure as simultaneous if they occur or begin within a concurrent tap threshold period of time of each other. The computing device 100 may also apply a lower pressure threshold, such as half, to the second tap, click, contact, or application of pressure. If the two taps, clicks, contacts, or applications of pressure meet the respective timing and pressure thresholds, and optionally other criteria described below, then the computing system 100 may treat the two taps, clicks, contacts, or applications of pressure as a single gesture, such as a right-click or right mouse click, according to an example embodiment.

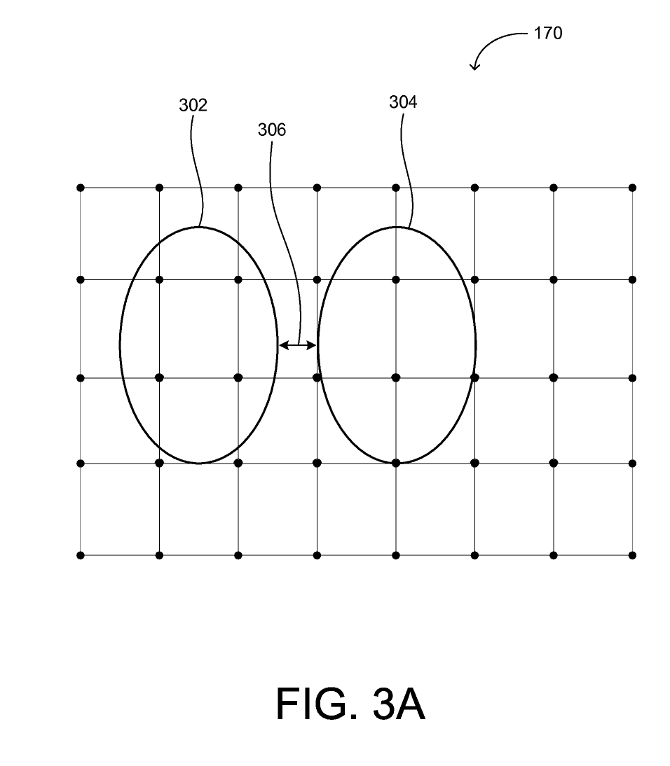

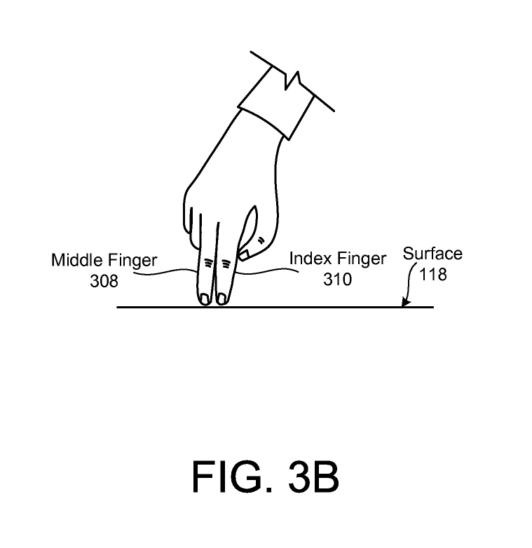

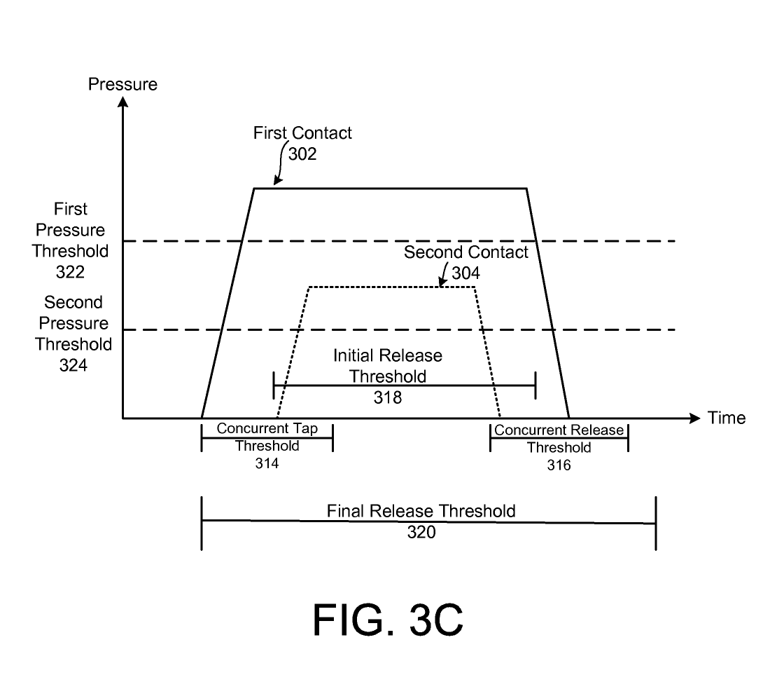

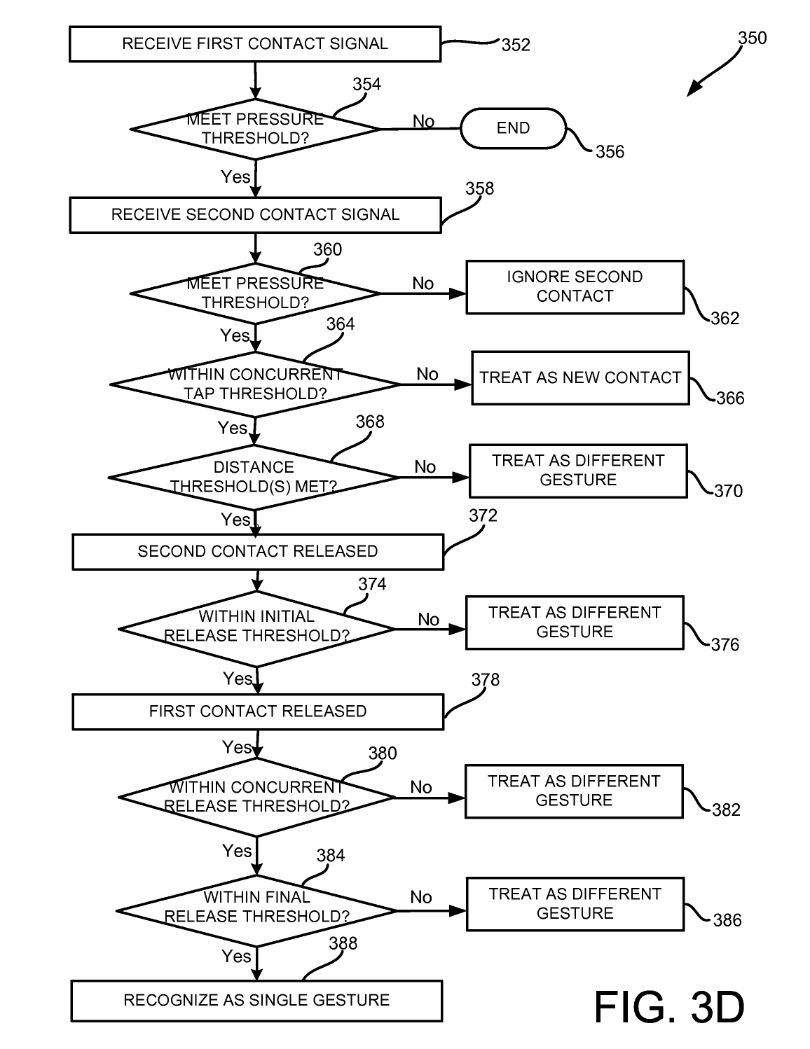

FIG. 3A is a diagram of the sensor grid 170 showing a distance 306 between two non-overlapping taps, contacts 302, 304, or applications of pressure detected on the tactile input device 110 (not shown in FIG. 3A) according to an example embodiment. The contacts 302, 304 may be examples of the input 172 shown in FIG. 1C. The non-overlapping contacts 302, 304 may not be fully concurrent in time. The first contact 302 may have begun first, and after the initiation of the first contact 302, while the first contact 302 is still on the tactile input device 110 and detected by the sensor 152 (not shown in FIG. 3A), and be followed by the second contact 304, with the first contact 302 being maintained while the second contact 304 is made. A distance 306 may be measured from opposing or near outer portions of the contacts 302, 304, as shown in FIG. 3A, or may be measured from other portions of the contacts 302, 304, such as from central portions or farthest outer portions of the contacts 302, 304 according to example embodiments. The tactile input device 110 may average multiple distances, or take a longest or shortest distance, between the contacts 302, 304, to determine whether the two contacts 302, 304 were within the threshold distance of each other. The computing device 100 may require the two contacts 302, 304 to be within a maximal distance of each other to recognize the two contacts 302, 304 as a single gesture (such as a right-click), ensuring, for example, that the two contacts 302, 304 are from adjacent fingers of the same hand, and/or may require the contacts 302, 304 to be at least a minimal threshold distance from each other to recognize the two contacts 302, 304 as a single gesture (such as a right-click), ensuring, for example, that the two contacts 302, 304 are from different fingers.

The contacts 302, 304 may result from a user tapping his or her finger on the surface 118 of the tactile input device 110. FIG. 3B is a diagram showing two fingers 308, 310 contacting the surface 118 of the tactile input device 118 according to an example embodiment. The user's first or middle finger 308 may be longer than the user's second or index finger 310, causing the first or middle finger 308 to contact the surface 118 before the second or index finger 310, and the first or middle finger 308 to withdraw from or stop contacting the surface 118 after the second or index finger. While the middle and index fingers 308, 310 are shown in this example, other combinations of figures may also be used.

FIG. 3C is a graph showing contacts 302, 304 and thresholds 322, 324 on the tactile input device 110 (not shown in FIG. 3C) according to another example embodiment. The first contact 302 may be made with the surface 118 (not shown in FIG. 3C), and the computing device 100 (not shown in FIG. 3C) may compare the first contact 302 to a first pressure threshold 322 to determine whether to recognize or ignore the first contact 302. The second contact 304 may also be made with the surface 118, and the computing device 100 may compare the second contact to a second pressure threshold 324 to determine whether to recognize or ignore the second contact 304. The second pressure threshold 324 may be lower than the first pressure threshold 324, such as about half, or within 40-60%, of the first pressure threshold 322, which may account for the shorter length of the second or index finger 310.

The computing device 100 may also compare the applications or taps, as well as the releases, of the first and second contacts 302, 304, to a concurrent tap threshold 314 period of time and a concurrent release threshold 316 period of time, respectively. The concurrent tap threshold 314 and concurrent release threshold 316 may ensure that the first and second contacts 302, 304 began and ended closely enough in time to each other for the computing system 100 to consider the first and second contacts 302, 304 to have begun and/or ended simultaneously or at the same time and recognize the first and second contacts as a single gesture (such as a right-click and/or right mouse click).

The computing device 100 may also determine whether at least one of, or both of, the first and second contacts 302, 304 were released quickly enough for the simultaneous contacts to be considered a tap or click rather than a drag, scroll, or other gesture. For example, the computing system 100 may determine whether at least one of the first and second contacts 302, 304, such as the second contact 304, was released within an initial release threshold 318 period of time after the contact 302, 304 began. The computing system 100 may also determine whether both of the first and second contacts 302, 304 were released within a final release threshold 320 period of time after the first contact 302 began. The computing system 100 may require one or both of the initial release threshold 318 and final release threshold 320 to have been met to consider the first and second contacts 302, 304 as a single gesture, such as a right-click or right mouse click.

FIG. 3D is a flow diagram of an exemplary process 350 that may be used to recognize a single gesture. The order of operations shown in FIG. 3D is merely an example, and the operations may occur in other orders than that shown in FIG. 3D. The computing system 100, including the controller 154, kernel driver 158, and/or gesture library 160, may receive a signal from the sensor 152 of the tactile input device 110 (352). The signal may represent the first contact 302 of the user's first or middle finger 308 on the surface 118 of the tactile input device 110. While the “signal” has been referred to as a single signal indicating the initiation of the first contact 302, the “signal” may include multiple signals indicating the initiation and maintaining of the first contact 302.

The computing system 100 may determine whether the first contact 302 meets the first pressure threshold 322 (354). If the first contact 302 does not meet the first pressure threshold 322, then the computing system 100 may ignore the first contact 302, and the process may end (356). If the first contact 302 does meet the first pressure threshold 322, then the computing system 100 may listen for the second contact 304.

The computing system 100 may receive another signal from the sensor 152 (358). The signal may represent the second contact 304 of the user's second or index finger 310 on the surface 118 of the tactile input device 110. While the “signal” has been referred to as a single signal indicating the initiation of the second contact 304, the “signal” may include multiple signals indicating the initiation and maintaining of the second contact 304.

The computing system 100 may determine whether the second contact 304 meets the second pressure threshold 324 (360). The second pressure threshold 324 may be less than the first pressure threshold 322, such as half, 40%, 50%, or 60% of the first pressure threshold 322, according to example embodiments, to accommodate the shorter length of the user's second or middle finger 310. If the second contact 304 does not meet the second pressure threshold 324, the computing device 100 may ignore the second contact 304 (366).

The computing system 100 may also determine whether the first and second contacts 302, 304 were within a central area of the tactile input device 110. The central area is discussed further with respect to FIG. 4B. If either the first or second contact 302, 304 was not within the central area, then the computing device 100 may ignore the contact 302, 304 that was not within the central area for the purpose of recognizing the single gesture (388).

If the first and second pressure thresholds 322, 324 are met, and the first and second contacts were within the central area, then the computing device 100 may determine whether the first and second contacts 302, 304 occurred or began closely enough in time by determining whether the first and second contacts 302, 304 began within the concurrent tap threshold 314 period of time of each other (364). If the first and second contacts 302, 304 did not begin within the concurrent tap threshold 314 of each other, then the computing device 100 may treat the second contact 304 as a new contact, separate and/or distinct from the first contact 302 (366).

If the first and second contacts 302, 304 were within the concurrent tap threshold 314, then the computing device 100 may determine whether the first and second contacts 302, 304 met a distance threshold(s) (368). The computing device 100 may, for example, determine whether the first and second contacts 302, 304 were within a maximal threshold distance and/or at least a minimal threshold distance of each other. The distances may be based on circular radii from the first contact 302, or may be based on square, rectangular, or elliptical areas around the first contact 302. The shape and/or threshold distance from the first contact 302 may be based on whether the fingers 308, 310 are vertically or horizontally spaced apart from each other. For example, a minimum distance between the contacts 302, 304 and/or fingers 308, 310 may be circular or square, requiring the two contacts 302, 304 and/or fingers 308, 310 to be at least one centimeter (for example) apart from each other in any direction. A maximum distance between the contacts 302, 304 and/or fingers 308, 310 may be three centimeters (for example) vertically and five centimeters (for example) horizontally, in an example in which the maximum distance threshold is based no either an elliptical or square area around the first contact 302.

If either or both distance thresholds were not met, then the computing device 100 may treat the first and second contacts 302, 304 as a different gesture than the single gesture such as the right-click or right mouse click (370). If the first and second contacts 302, 304 are too far apart, for example, the computing device 100 may treat the first and second contacts 302, 304 as separate clicks, taps, or drags, whereas if the first and second contacts 302, 304 are too close to each other, the computing device 100 may treat the first and second contacts 302, 304 as a single contact.

After the first and second contacts 302, 304 have been applied, and their respective signals received (352, 358), the second contact 304 may be released (372). The computing system 100 may determine whether the second contact 304 (or first contact 302) was released within an initial release threshold 318 from an initiation or beginning of the second contact 304 (374). If the second contact 304 (or first contact 302) was not released within the initial release threshold 318, then the computing system 100 may treat the first and second contacts 302, 304 as a different gesture (376), such as a scroll. If the second contact 304 is released within the initial release threshold 318, then further determinations may be made with respect to release of the first contact 302.

The first contact 302 may be released after the second contact 304 (378), or the second contact 304 may be released after the first contact 302. The computing system 100 may determine whether the first and second contacts 302, 304 were released within a concurrent release threshold 316 of each other (380). The concurrent release threshold 316 may ensure that the fingers 308, 310 are pulled up at nearly the same time. If the first and second contacts 302, 304 are not released within the concurrent release threshold 316, then the computing system 100 may treat the first and second contacts 302, 304 as a different gesture (382) than the single gesture such as the right-click or right mouse click.

If the first and second contacts 302, 304 were released within the concurrent release threshold 316 of each other, then the computing system 100 may determine whether the first and second contacts 302, 304 were both released within a final release threshold 320 of when the first contact 302 began (384). The final release threshold 320 may ensure that the user is tapping or clicking and releasing, rather than leaving his or her fingers 308, 310 down for some other reason. If the first and second contacts 302, 304 are not released within the final release threshold 320 of when the first contact 302 began, then the computing device 100 may treat the first and second contacts 302, 304 as a different gesture (386) than the single gesture such as the right-click or right mouse click.

If the first and second contacts 302, 304 are released within the final release threshold 320 of when the first contact 302 began, then the computing device 100 may treat the first and second contacts 302, 304 as a single gesture (388). The computing device 100 may treat the first and second contacts 302, 304 as a right-click or right mouse click, for example.

When the user is tapping or dragging along the tactile input device 100, the user may accidentally or inadvertently brush the tactile input device 100 with his or her palm. It may be desirable to ignore the brushing of the tactile input device 100 by the user's palm.

In an example embodiment, the computing system 100 may disable the recognition of the single gesture (388) after the computing system has received input via the keyboard 180. The computing system 100 may disable the recognition of the single gesture after receiving a non-modifier key input on the keyboard 180, where a non-modifier key input includes receiving non-modifier key input, or any key input other than control (Ctrl-), shift (Shift-), or alter (Alt-), because these keys (or modifier inputs) may modify the gesture or tactile input device 110 input. The computing device 100 may disable the recognition of the single gesture for a keystroke threshold period of time after the keyboard 180 input, such as one hundred milliseconds or five hundred milliseconds, or a power of two, such as one hundred twenty-eight milliseconds, two hundred fifty-six milliseconds, or five hundred twelve milliseconds, as non-limiting examples.

FIG. 4A is a diagram of the sensor grid 170 showing a first or intentional contact 402 and an inadvertent contact 404 detected on the tactile input device 110 (not shown in FIG. 4A) according to an example embodiment. The first contact 402 may be moving or stationary. The contacts 402, 404 may be examples of the input 172 shown in FIG. 1C. The first contact 402 may be caused by the user intentionally touching the tactile input device 110 with a finger, and holding, dragging, or swiping the finger to the right along the tactile input device 110. While the user is holding, dragging, or swiping the finger along the tactile input device 110, his or her palm may accidentally or incidentally contact the bottom of the tactile input device 110, generating the contact 404 at the bottom of the sensor grid 170. The computing device 100 may, for example, ignore the inadvertent contact 404 if the inadvertent contact occurred at least a threshold period of time, such as an ignore threshold period of time, after the first contact 402, and if the first contact 402 is moving while the inadvertent contact 404 begins.

The computing device 100 may determine whether to recognize a contact, such as the inadvertent contact 404 shown in FIG. 4A, based on a location of the contact 404. FIG. 4B is a diagram of the sensor grid 170 showing a central area 170A and an outer area 170B according to an example embodiment. The outer area 170B may be an area around the perimeter of the tactile input device 110, such as within one centimeter, or some other fixed distance, from an edge of the tactile input device 110. The central area 170A may be a remaining area which is not part of the outer area. The computing device 100 may, for example, ignore the inadvertent contact 404 if the inadvertent contact occurred at least the threshold period of time, such as the ignore threshold period of time, after the first contact 402, if the moving contact 402 is moving while the inadvertent contact 404 begins, and/or if the inadvertent contact 404 occurred outside the central area 170A and/or inside the outer area 170B.

FIG. 4C is a flow diagram of an exemplary process 450 that may be used to ignore the inadvertent contact 404 with the tactile input device 110. The order of operations shown in FIG. 4C is merely an example, and the operations may occur in other orders than that shown in FIG. 4C. The computing system 100, including the controller 154, kernel driver 158, and/or gesture library 160, may receive a signal from the sensor 152 of the tactile input device 110 (452). The signal may represent the moving contact 402 of the user's finger 210 on the surface 118 of the tactile input device 110. The signal may also indicate the motion of the first contact 402. While the “signal” has been referred to as a single signal indicating the initiation and motion of the moving contact 402, the “signal” may include multiple signals indicating the initiation, motion, and/or multiple locations of the moving contact 402.

The computing system 100, including the controller 154, kernel driver 158, and/or gesture library 160, may receive another signal from the sensor 152 of the tactile input device 110 (454). The signal may represent the inadvertent contact 404, such as the user's palm on the surface 118 of the tactile input device 110. The signal may also indicate the location of the inadvertent contact 404, such as whether the inadvertent contact was inside the central area 170A or outer area 170B.

The computing system 100 may determine whether the inadvertent contact 404 occurred a threshold time (such as ignore threshold time) after or later from the moving contact 402 (456). If the inadvertent contact did not occur the threshold time after the moving contact 402, then the computing system 100 may determine whether the inadvertent contact 404 and moving contact 402 are part of a same gesture (458).

If the computing system 100 determines that the inadvertent contact 404 occurred the threshold time after the moving contact 402, then the computing system 100 may determine whether the moving contact 402 is moving at the time of the inadvertent contact 404 (460). If the moving contact 402 was not moving at the time of the inadvertent contact 404, then the computing system 100 may recognize the moving contact 404 as a second contact (462).

If the computing system 100 determines that the moving contact 402 was moving when the inadvertent contact 404 was received, then the computing system 100 may either ignore the inadvertent contact 404 (468) or determine whether the inadvertent contact 404 was outside the central area 170A (or inside the outer area 170B) (464). If the computing system 100 determines that the inadvertent contact 404 was inside the central area 170A (or not inside the outer area 170B), then the computing system 100 may recognize the inadvertent contact 404 as a second contact (466). If the computing system 100 determines that the inadvertent contact 404 was outside the central area 170A (or inside the outer area 170B), then the computing system 100 may ignore the inadvertent contact 404 (468).

The computing system 100 may also ignore the inadvertent contact 404 based on the inadvertent contact 404 being received within a keystroke threshold time after receiving a keystroke, and/or within the keystroke threshold time after receiving a non-modifier keystroke, where modifier keystrokes include keys such as control (Ctrl-) and alter (Alt-).

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a non-transitory computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A non-transitory computer-readable storage medium comprising instructions stored thereon for recognizing gestures on a tactile input device that, when executed by at least one processor, are configured to cause a computing system to at least:
receive, from a sensor of the tactile input device, a signal representing a first contact on the tactile input device and subsequent release of the first contact from the tactile input device;
receive, from the sensor of the tactile input device, a signal representing a second contact on the tactile input device after the first contact is released, the second contact being maintained and changing location on the tactile input device; and
recognize the first contact and the second contact as a single gesture if:
the second contact occurs within a re-tap threshold period of time after the first contact; and
the second contact begins within a maximal threshold distance on the tactile input device from the first contact.

2. The computer-readable storage medium of claim 1, wherein the signal representing the first contact is received from the sensor of the tactile input device via a controller coupled to the sensor and the signal representing the second contact is received from the sensor of the tactile input device via the controller.

3. The computer-readable storage medium of claim 1, wherein the recognizing the first contact and the second application as the single gesture includes recognizing the first contact and the second contact as a press-and-move mouse gesture.

4. The computer-readable storage medium of claim 1, wherein:
the recognizing the first contact and the second contact as the single gesture includes recognizing the first contact and the second contact as a press-and-move mouse gesture; and
the instructions are further configured to cause the computing system to:
receive, from the sensor of the tactile input device, a signal representing a release of the second contact; and
recognize the signal representing the release of the second contact as a mouse release event after the press-and-move mouse gesture.

5. The computer-readable storage medium of claim 1, wherein the recognizing the first contact and the second application as the single gesture includes recognizing the first contact and the second contact as the single gesture, the single gesture including:
a mouse pressed event; and
a mouse dragged event.

6. The computer-readable storage medium of claim 1, wherein:
the recognizing the first contact and the second contact as the single gesture includes recognizing the first contact and the second contact as the single gesture, the single gesture including:
a mouse pressed event; and
a mouse dragged event; and
the instructions are further configured to cause the computing system to:
receive, from the sensor of the tactile input device, a signal representing a release of the second contact; and
recognize the signal representing the release of the second contact as a mouse release event after the mouse pressed event and the mouse dragged event.

7. The computer-readable storage medium of claim 1, wherein the recognizing the first contact and the second contact as the single gesture includes recognizing the first contact and the second contact as the single gesture if:
the second contact occurred within the threshold period of time after the first contact;
the second contact began within the threshold distance from the first contact;
the first contact met a tap threshold of pressure; and
the second contact met the tap threshold of pressure.

8. The computer-readable storage medium of claim 1, wherein the recognizing the first contact and the second application as the single gesture includes recognizing the first contact and the second contact as the single gesture if:
the second contact occurred within the threshold period of time after the first contact;
the second contact began within the threshold distance from the first contact; and
the second contact applied an amount of pressure that is within a threshold difference from the amount of pressure applied by the first contact.

9. The computer-readable storage medium of claim 1, wherein the recognizing the first contact and the second contact as the single gesture comprises recognizing the first contact and the second contact as the single gesture if:
the second contact occurred within the threshold period of time after the first contact;
the second contact began within the threshold distance from the first contact;
the first contact was received within a central area of the sensor of the tactile input device; and
the second contact was received within the central area of the sensor of the tactile input device.

10. The computer-readable storage medium of claim 1, wherein the recognizing the first contact and the second application as the single gesture includes recognizing the first contact and the second contact as the single gesture if:
the second contact occurred within the threshold period of time after the first contact;
the second contact began within the threshold distance from the first contact; and
a keystroke input was not received within a keystroke threshold period of time before the first contact.

11. The computer-readable storage medium of claim 1, wherein the recognizing the first contact and the second application as the single gesture includes recognizing the first contact and the second contact as the single gesture if:
the second contact occurred within the threshold period of time after the first contact;
the second contact began within the threshold distance from the first contact; and
a non-modifier keystroke input was not received within a keystroke threshold period of time before the first contact.

12. The computer-readable storage medium of claim 1, wherein the recognizing the first contact and the second application as the single gesture includes recognizing the first contact and the second contact as the single gesture if:
the first contact was released within a release threshold period of time from an initiation of the first contact;
the second contact began within a re-tap threshold period of time from the release of the first contact; and
the second contact occurred within the threshold distance from the first contact.

13. The computer-readable storage medium of claim 1, wherein the recognizing the first contact and the second application as the single gesture includes recognizing the first contact and the second contact as the single gesture if:
the second contact occurred within the threshold period of time after the first contact;
the second contact occurred within the threshold distance from the first contact; and
the second contact remained stationary for a stationary threshold of time before changing location.

14. The computer-readable storage medium of claim 1, wherein the recognizing the first contact and the second contact as the single gesture includes recognizing the first contact and the second contact as the single gesture if:
the first contact was released within a release threshold period of time from the initiation of the first contact;
the second contact occurred within the re-tap threshold period of time from the release of the first contact;
the second contact occurred within the threshold distance from the first contact; and
the second contact remained stationary for a stationary threshold of time before changing location.

15. The computer-readable storage medium of claim 1, wherein the recognizing the first contact and the second contact as the single gesture includes recognizing the first contact and the second contact as the single gesture if:
the second contact at least a pause threshold period of time after a release of the first contact;
the second contact occurred within the re-tap threshold period of time from the release of the first contact;
the second contact occurred within the threshold distance from the first contact

16. The computer-readable storage medium of claim 1, wherein the instructions are further configured to cause the computing device to send a mouse pressed signal and a mouse dragged signal to an application executing on the computing system.

17. The computer-readable storage medium of claim 1, wherein the instructions are further configured to cause the computing device to display an object on a display of the computing device being dragged across the display based on the recognizing the first contact and the second contact as the single gesture.

18. A non-transitory computer-readable storage medium comprising instructions stored thereon for recognizing gestures on a tactile input device that, when executed by at least one processor, are configured to cause a computing system to at least:
receive, from a sensor of the tactile input device, a signal representing a first contact on the tactile input device;
receive, from the sensor of the tactile input device, a signal representing a second contact on the tactile input device; and
recognize the first contact and the second contact as simultaneous if:
the second contact begins within a concurrent tap threshold time of when the first contact begins;
the second contact begins within a maximal threshold distance of the first contact; and
the first and second contacts are released within a concurrent release threshold time of each other.

19. The computer-readable storage medium of claim 18, wherein the recognizing the first contact and the second contact as simultaneous comprises recognizing the first contact and the second contact as simultaneous if:
the second contact began within the concurrent tap threshold time of when the first contact began, the second contact beginning after the first contact;
the second contact began within the maximal threshold distance of the first contact;
the first contact meets a first minimum pressure threshold;
the second contact meets a second minimum pressure threshold, the second minimum pressure threshold being less than the first minimum pressure threshold; and
the first and second contacts are released within the concurrent release threshold time of each other.

20. The computer-readable storage medium of claim 18, wherein the recognizing the first contact and the second contact as simultaneous comprises recognizing the first contact and the second contact as simultaneous if:
the second contact began within the concurrent tap threshold time of when the first contact began, the second contact beginning after the first contact;
the second contact began within the maximal threshold distance of the first contact;
the first contact meets a first minimum pressure threshold;
the second contact meets a second minimum pressure threshold, the second minimum pressure threshold being less than half the first minimum pressure threshold; and
the first and second contacts are released within the concurrent release threshold time of each other.

21. The computer-readable storage medium of claim 18, wherein the recognizing the first contact and the second contact as simultaneous comprises recognizing the first contact and the second contact as simultaneous if:
the second contact began within the concurrent tap threshold time of when the first contact began, the second contact beginning after the first contact;
the second contact began within the maximal threshold distance of the first contact;
the second contact began at least a minimal threshold distance of the first contact; and
the first and second contacts are released within the concurrent release threshold time of each other.

22. The computer-readable storage medium of claim 18, wherein the recognizing the first contact and the second contact as simultaneous comprises recognizing the first contact and the second contact as simultaneous if:
the second contact began within the concurrent tap threshold time of when the first contact began, the second contact beginning after the first contact;
the second contact began within the maximal threshold distance of the first contact;
the second contact is released within a first threshold time of a beginning of the second contact; and
the first and second contacts are released within the concurrent release threshold time of each other.

23. The computer-readable storage medium of claim 18, wherein the recognizing the first contact and the second contact as simultaneous comprises recognizing the first contact and the second contact as simultaneous if:
the second contact began within the concurrent tap threshold time of when the first contact began, the second contact beginning after the first contact;
the second contact began within the maximal threshold distance of the first contact;
the first and second contacts are released within a final release threshold time from a beginning of the first contact; and
the first and second contacts are released within the concurrent release threshold time of each other.

24. The computer-readable storage medium of claim 18, wherein the recognizing the first contact and the second contact as simultaneous comprise recognizing the first contact and the second contact as a right-click.

25. A non-transitory computer-readable storage medium comprising instructions stored thereon for ignoring spurious clicks on a tactile input device that, when executed by at least one processor, are configured to cause a computing system to at least:
receive, from a sensor of the tactile input device, a signal representing a first contact on the tactile input device, the first contact being maintained and moving across the tactile input device;
receive, from the sensor of the tactile input device, a signal representing a second contact on the tactile input device, the second contact beginning:
at least a threshold period of time after a beginning of the first contact; and
while the first contact is moving across the tactile input device; and
ignore the second contact based on the second contact beginning at least the threshold period of time after the beginning of the first contact and while the first contact is moving across the tactile input device.

26. The computer-readable storage medium of claim 25, wherein:
the second contact was received outside of a central area of the tactile input device; and
the ignoring the second contact includes ignoring the second contact based on:
the second contact beginning at least the threshold period of time after the beginning of the first contact and while the first contact is moving across the tactile input device; and
the second contact being received outside of the central area of the tactile input device.

27. A computing system comprising:
a display;
a tactile input device comprising at least one sensor;
at least one processor configured to execute instructions, receive input signals from the at least one sensor of the tactile input device, and send output signals to the display; and
at least one memory device comprising instructions stored thereon that, when executed by the at least one processor, are configured to cause the computing system to at least:
present, by the display, an object being dragged across the display based on:
a first drag contact and a second drag contact received on the sensor of the tactile input device, the second drag contact beginning within a re-tap threshold period of time after the first drag contact on the sensor is released; and
the second drag contact beginning within a maximal threshold distance on the sensor from the first contact.

28. The computing device of claim 27, wherein the instructions stored on the at least one memory device are further configured to cause the computing system to process a right-click if:
a first right-click contact on the sensor begins within a concurrent tap threshold time of when a second right-click contact on the sensor begins;
the first right-click contact begins within a right-click maximal threshold distance of the second right-click contact; and
the first and second right-click contacts are released within a concurrent released threshold time of each other.

29. The computing device of claim 27, wherein the instructions stored on the at least one memory device are further configured to cause the computing system to ignore an inadvertent contact on the sensor based on a moving contact on the sensor beginning at least an ignore threshold period of time after a beginning of the moving contact and while the moving contact is moving across the tactile input device.

30. The computing system of claim 27, wherein the tactile input device is a trackpad.
